(19) United States
(12) Patent Application Publication
(10) Pub. No.: US 2019/0374972 A1
(43) Pub. Date: Dec. 12, 2019

(54) Apparatus with a Retaining Cage

(71) Applicant: Danco, Inc., Irving, TX (US)

(72) Inventors: Michael J. Schuster, Shorewood, IL (US); Thomas R. Bajek, Naperville, IL (US); Douglas C. Saunders, Plainfield, IL (US)

(21) Appl. No.: 16/438,157

(22) Filed: Jun. 11, 2019

Related U.S. Application Data
(60) Provisional application No. 62/683,739, filed on Jun. 12, 2018.

(51) Int. Cl. B05C 17/00

(52) U.S. Cl. CPC B05C 17/00

(57) ABSTRACT

Disclosed are various embodiments for an applicator configured to receive a stick. In one embodiment, the applicator includes a pad and an adapter. The adapter includes a top side and a bottom side, where the adapter retains the pad on the bottom side. The adapter also includes a retaining cage on the top side. The retaining cage includes a first end and a second end, where the retaining cage extends from the adapter at the first end. The retaining cage comprises an opening at the second end for receiving a stick.

### CROSS-REFERENCE TO RELATED APPLICATIONS

This application claims priority to, and the benefit of, co-pending U.S. provisional application entitled “AN APPARATUS WITH A RETAINING CAGE” having Ser. No. 62/683,739, filed Jun. 12, 2018, the contents of which are incorporated by reference in their entirety.

### BACKGROUND

Paint brushes can be difficult to manage along edges of walls and confined areas. Oftentimes, paint edgers can be used to prevent paint from being applied on another surface, such as a baseboard, crown molding, door trim, or an adjacent wall. Generally, these tools have a flat surface for applying the paint and a protruding handle for manipulating the tool along the wall.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A and 1B illustrate a perspective view of a top side and bottom side of an applicator, respectively, according to one embodiment described herein.

FIG. 2 illustrates an exploded view of the components of the applicator shown in FIGS. 1A and 1B, according to one embodiment described herein.

FIGS. 3A through 3G illustrate views of the adapter and its associated components from FIGS. 1A and 1B, according to one embodiment described herein.

FIGS. 4A through 4F illustrate various views of a spring clip from FIG. 1A, according to one embodiment described herein.

FIGS. 5A-5C illustrate an exemplary progression of inserting a paint stick into a first retaining cage on the applicator from FIG. 1A, according to one embodiment described herein.

FIGS. 6A-6C illustrate an exemplary progression of inserting a paint stick into a second retaining cage on the applicator from FIG. 1A, according to one embodiment described herein.

FIG. 7 illustrates an exemplary scenario of using the applicator behind a toilet, according to one embodiment described herein.

### DETAILED DESCRIPTION

Paint edgers can generally be used to paint in areas that are difficult to manage for a typical paint brush. Generally, paint edgers can have a flat surface for applying paint and a handle that protrudes away from the flat surface. Paint edgers and other painting tools can be difficult to maneuver in confined areas, such as behind a toilet, behind a flat screen mounted television, and other similar spaces.

Oftentimes, painting tools have rigid components that can be difficult to use in these confined areas. For example, some painting tools may have a handle fixed at an angle from the flat surface that applies the paint. The handle may come into contact with nearby objects as a user tries to paint in confined areas. In other cases, painting tools may have a roller brush or bristles. These painting tools can be difficult to manage in confined areas because it can difficult to keep the brush or bristles from applying paint in unwanted areas when painting in confined spaces.

The present disclosure relates to an adjustable paint applicator that can be used to paint along edges, confined spaces, and other difficult areas. Additionally, the paint applicator can be used with standard paint sticks, which are commonly available at paint stores. Various embodiments of the paint applicator include an adapter, which in turn comprises one or more retaining cages for securing a paint stick to the paint applicator. The paint stick can function as a handle for a user. In many cases, paint sticks are longer in length than a handle of commonly used paint edgers or roller brushes, which provides a greater reach for a user in tight areas. Additionally, with the paint stick inserted, the retaining cage may have freedom to pivot away from the paint pad. This pivoting action provides users with a greater degree of flexibility for operating the paint applicator. In comparison with a tool with a fixed handle, the user can operate the paint applicator to a greater degree from a user's wrist. In contrast, a fixed handle can force a user to use more of their arm to move the painting tool along a flat surface. Further, the structure of the components of the paint applicator enable it to have a thin profile, which is useful for painting in confined areas.

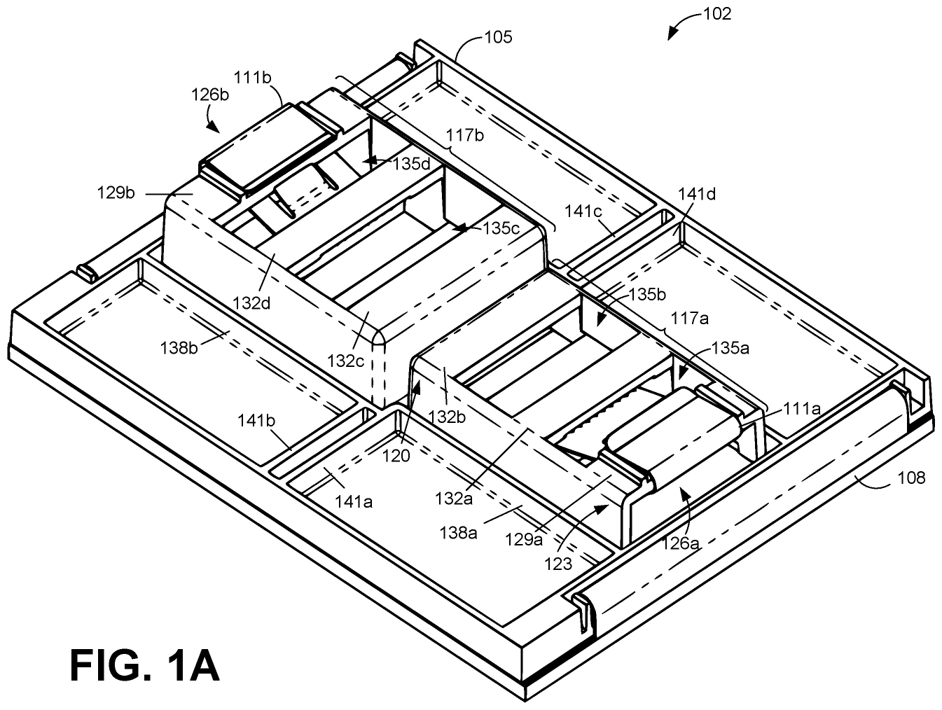

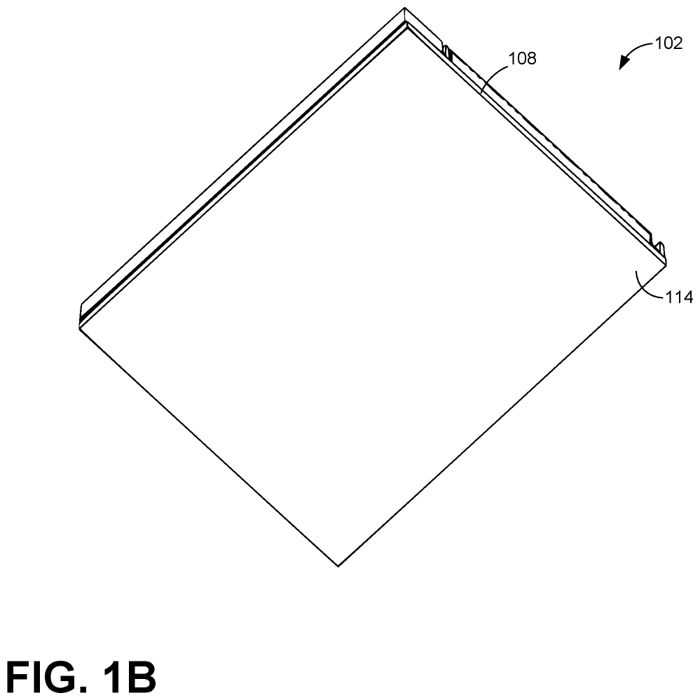

Turning to the drawings, a general description of embodiments of an applicator and its components is provided, followed by a discussion of the operation of the same. With reference to FIG. 1A, a perspective top side view of an applicator 102 is shown. FIG. 1B illustrates a perspective bottom side view of the applicator 102. The applicator 102 includes an adapter 105 that is positioned above a backing 108. The applicator 102 may also include a first spring clip 111a and a second spring clip 111b (collectively “the spring clips 111”) that are fasten to portions of the adapter 105. Additionally, as shown in FIG. 1B, the applicator 102 includes a pad 114 that is connected to the backing 108. The pad 114 can be used for applying paint on surface. As one skilled in the art can appreciate, the pad 114 can be used for other purposes besides painting. The pad 114 can comprise material such as a felt pad, a bristle pad, a foam pad, and other suitable materials. One skilled in the art can appreciate that the pad 114 may comprise of other suitable absorbent materials. In addition, the pad 114 may be a sandpaper pad and other suitable abrasive materials. In some embodiments, the pad 114 may be removable from the backing 108 or the adapter 105. In other embodiments, the pad 114 may be permanently attached to the backing 108 or the adapter 105.

The adapter 105 has a top side and a bottom side. On the top side, as shown in FIG. 1A, the adapter 105 includes a first retaining cage 117a and a second retaining cage 117b (collectively “the retaining cages 117”). The retaining cages 117 are enclosures that can be used for retaining a stick. The retaining cages 117 each have a first end and a second end. As shown, the first retaining cage 117a has a first end 120 and a second end 123. At the second end 123, the first retaining cage 117a has a first opening 126a for inserting a stick. Additionally, the first retaining cage 117a has a first retention bar 129a and raised cross bars 132a, 132b (collectively “raised cross bars 132”). The first retention bar 129a and the raised cross bars 132 form a first window aperture 135a and a second window aperture 135b (collectively “window apertures 135”). In some cases, the window apertures 135 are formed to simplify the molding process for manufacturing the adapter 105. As illustrated in FIG. 1A, the second retaining cage 117b has similar components as the first retaining cage 117a. Particularly, the second retaining cage 117b has a second opening 126b, raised crossed bars 132c, 132d, window apertures 135c, 135d, and a second retention bar 129b.

The retaining cages 117 can pivot away from a plane associated with the bottom side of the adapter 105. The pivoting action provides users with an additional range of motion when using the applicator 102.

Additionally, the adapter 105 may include a plurality of cage walls 138a, 138b (collectively “cage walls 138”) that extend along the sides of the retaining cages 117. As shown, the cage walls 138 are substantially parallel with the sides of the retaining cages 117. The cage walls 138 extend to a plurality of adapter walls 141a-141d (collectively “adapter walls 141”). As shown, the adapter walls 141 are substantially perpendicular to the cage walls 138. The adapter walls 141 and the cage walls 138 are used to provide rigidity to the adapter 105, which is useful in scenarios when one of the retaining cages 117 pivots away from a plane of the backing 108. In some embodiments, the cage walls 138 and/or the adapter walls 141 may be omitted from the adapter 105. For example, in some embodiments, the cage walls 138 and/or the adapter walls 141 may not be required because of the thickness of the adapter 105 or because of the material composition of the adapter 105.

The spring clips 111 may be used to secure a paint stick or other devices within the retaining cages 117. The spring clips 111 can include spring steel and other suitable materials. In some embodiments, the spring clips 111 may be omitted from the adapter 105. Instead, these embodiments can use other fasteners for securing the paint stick within the retaining cage 117. For example, a fastener could be inserted through one of the retention bars 129, through one of the raised cross bars 132, or through one of the window apertures 135. The fastener may include a screw, a nail, a tack, or other suitable fasteners. In other embodiments, a paint stick can be secured to a retaining cage 117 with an adhesive, such as glue, paste, or other suitable types of adhesives. Additionally, the paint stick can vary in width, thickness, and its material composition. The embodiments of the present disclosure can be configured to secure a variety of different sized paint sticks and other components used as a handle.

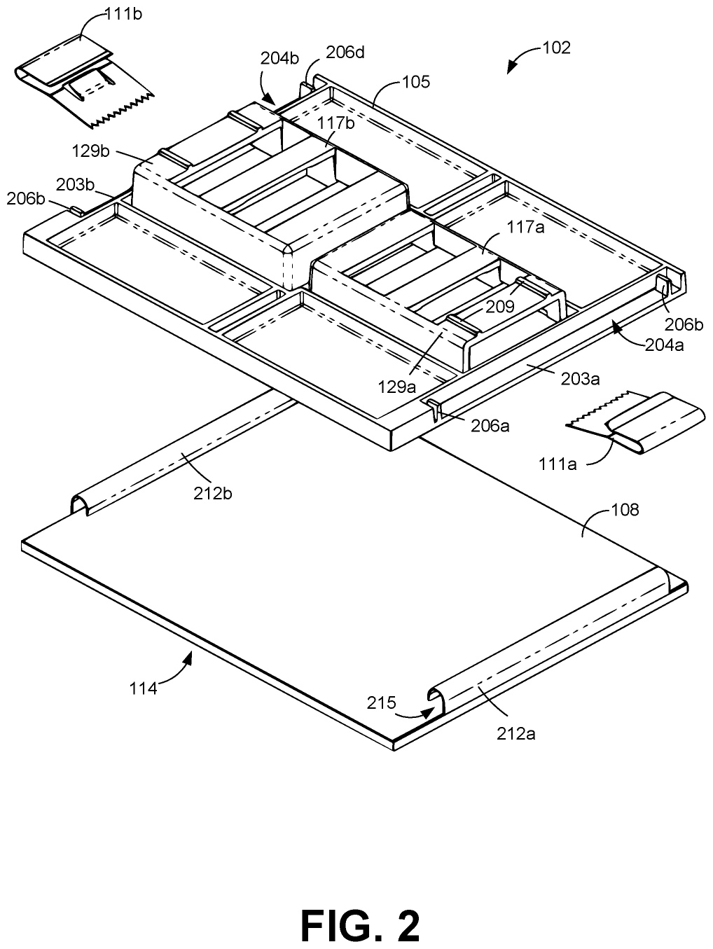

With reference to FIG. 2, shown is an exploded view of the components of the applicator 102 shown in FIGS. 1A and 1B, including the adapter 105, the first spring clip 111a, the second spring clip 111b, and the backing 108. In the illustrated embodiment, the adapter 105 includes a first edge 203a and a second edge 203b (collectively “the edges 203”) along on the perimeter of the adapter 105. The edges 203 of the adapter 105 include a first recessed channels 204a and a second recessed channel 204b (collectively “recessed channels 204”), where overhangs of the backing 108 are positioned. The recessed channels 204 may include a plurality of stops 206a-206d (collective “stops 206). The first recessed channel 204a includes a first stop 206a and a second stop 206b. The second recessed channel 204b includes a third stop 206c and a fourth stop 206d. The stops 206 can be used to contact a portion of the backing 108 and prevent the backing 108 for moving within the recessed channels 204. One or more of the stops 206 can be removed to adjust the length of the recessed channel 204a. By adjusting the length, the recessed channels 204 can accommodate various backings 108 manufactured by different entities. In some embodiments, the stops 206 is a knockout component. Within the recessed channels 204, various configurations of the stops 206 can be configured to fit various types of pads and various pad sizes. For example, one or more of the stops 206 can be removed from the recessed channel 204 in order to fit various different pads 114 and backings 108.

As illustrated, the retention bars 129 may have two raised edges 209 for guiding the placement of the spring clips 111. The raised edges 209 also keep a spring clip 111 from moving along a retention bar 129.

The backing 108 retains the pad 114 that is used for applying paint. The backing 108 includes a first overhang 212a at a first edge of the backing 108 and a second overhang 212b (collectively “overhangs 212”) at second edge of the backing 108. The overhangs 212 form a slot 215 because of its bent structure. In the illustrated embodiments, the overhangs 212 have a curved shape with an arm on one side, similar to the letter “J.” When attaching the backing 108 to the adapter 105, the overhangs 212 are positioned in the recessed channels 204. An end portion of the overhang 212 can be disposed in the recessed channel 204. Additionally, the sides of the overhangs 212 can come into contact with stops 206, which prevents the overhangs 212 from moving within the recessed channels 204. In other embodiments, the overhangs 212 can have a different shape. For example, an overhang 212 can extend out substantially horizontally from a side arm of the overhang 212, in which the overhang 212 could be configured similar to the letter “L.” As one skilled in the art can appreciate, the overhang 212 can be configured in other shapes.

In some embodiments, a recessed channel 204 can include a raised edge for mating with the overhang 212. In this embodiment, a top portion of the overhang 212 may move outward because of the raised edge. Once the top portion of the overhang 212 has cleared the raised edge, the overhang 212 can move inward toward the first end of the first retaining cage 117a to position the raised edge within the overhang 212.

In other embodiments, the overhangs 212 can be omitted. In this embodiment, the backing 108 can extend from the adapter 105, such as a single piece component. In other cases, the backing 108 can be connected to the adapter 105 by applying an adhesive between the two components.

With regard to assembling the applicator 102, one approach, among others, can include attaching the backing 108 to the bottom side of the adapter 105. This step can include aligning the backing 108 with the adapter 105 by situating the adapter 105 above the backing 108. The overhangs 212 can be positioned in the recessed channels 204. Then, the spring clips 111 can be inserted onto the adapter 105. Specifically, the retention bars 129 of the adapter 105 can be inserted through a slot of the spring clips 111, which causes a tab of the spring clip 111 to be placed against an inner wall of the retention bars 129. Next, a paint stick can be inserted into the first opening 126a of the first retaining cage 117a, which causes an edge of a spring clip 111 to apply a force against the paint stick. In other scenarios, a paint stick can be inserted in the second opening 126b of the second retaining cage 117b. In some embodiments, the spring clips 111 may be omitted from the adapter 105. Instead, for example, the retaining cages 117 can be configured to secure a stick or a handle by way of a friction fit. In this example, the retaining cages 117 may be configured in a wedge shape. Particularly, the first end 120 of the retaining cage 117a may have a smaller width than the second end 120. As the paint stick moves further inside of the retaining cage 117a, the paint stick can contact the sides of the retaining cage 117a and remain attached within the retaining cage 117a because of the tightness of the connection with paint stick. In other embodiments, the retaining cage 117 may use locking tabs, tacks, staples, and other suitable methods for securing the paint stick.

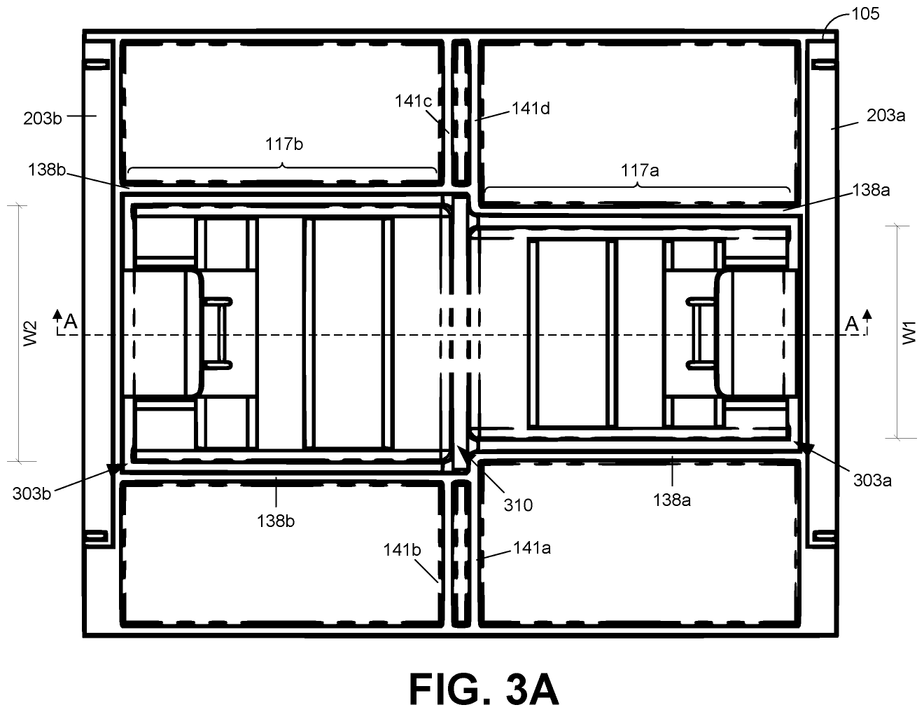

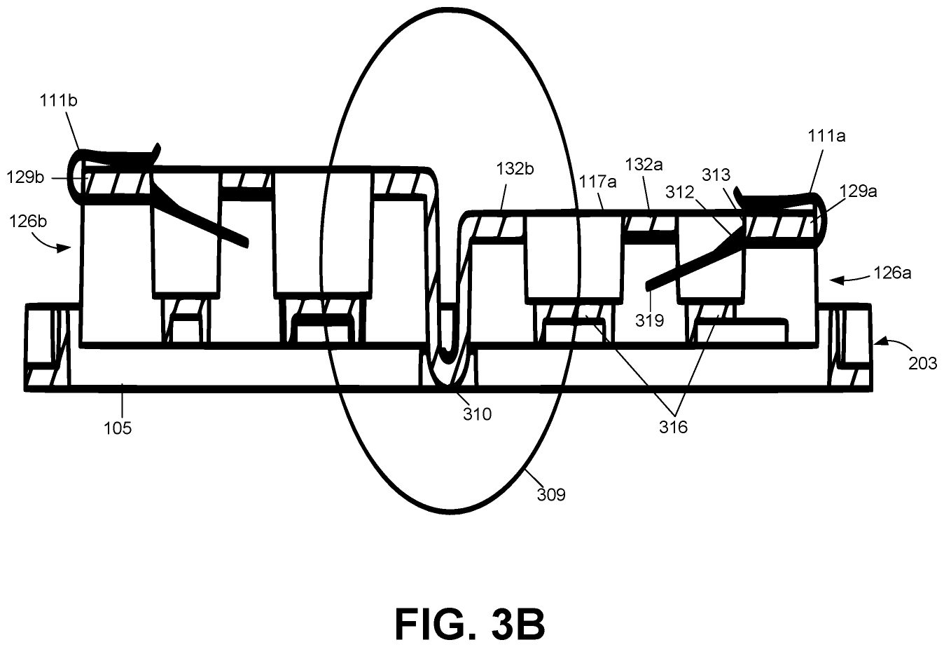

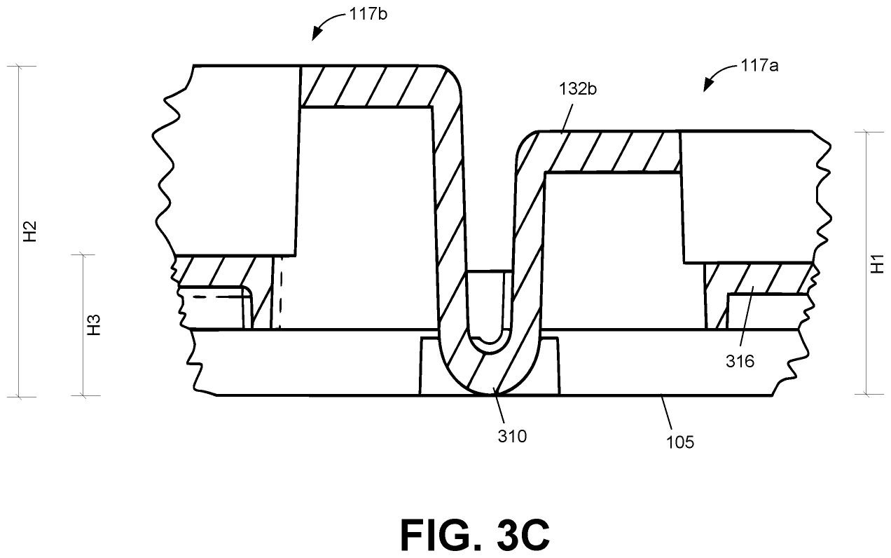

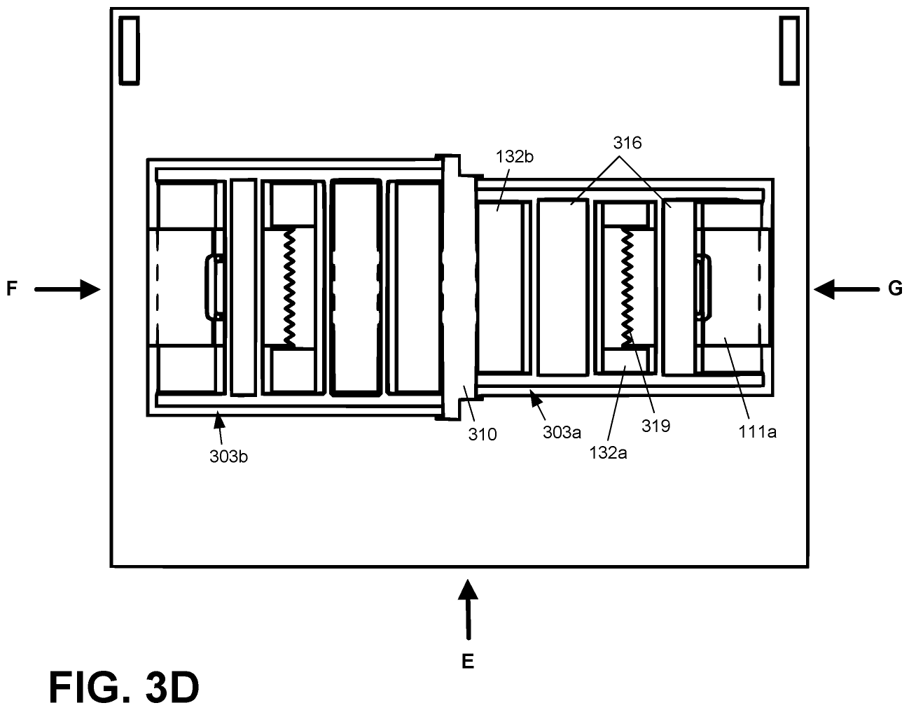

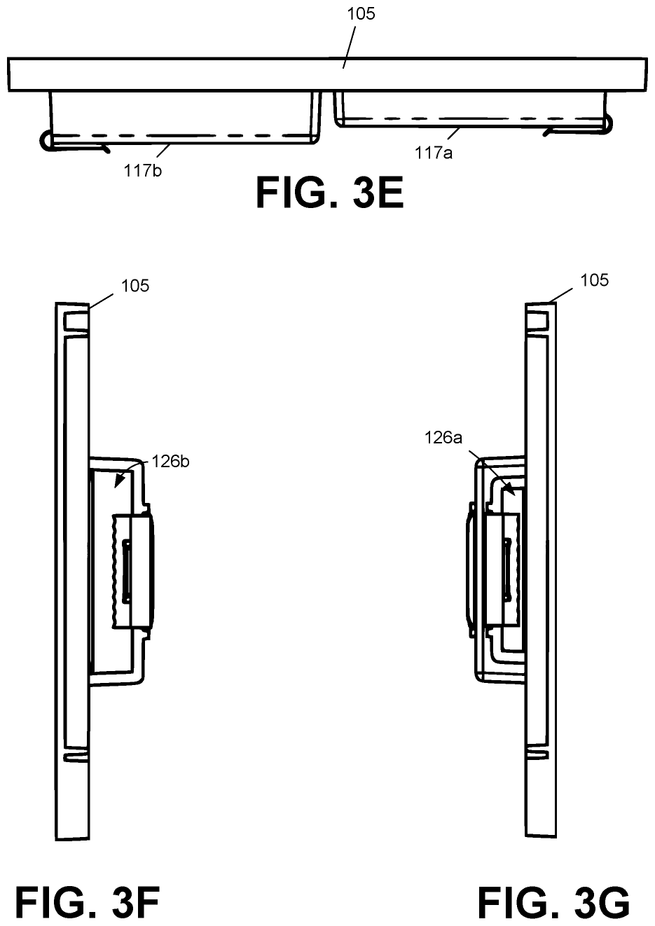

Next, referring to FIG. 3A, shown is a top view of the adapter 105 and the spring clips 111 from FIG. 1A. FIG. 3A includes a cross-sectional reference “A-A” for FIG. 3B. Additionally, the adapter 105 includes adapter apertures 303a, 303b that extend along the sides and an end of the retaining cages 117. Specifically, the adapter aperture 303a extends along the sides and the second end 123 of first retaining cage 117a. In other words, the adapter aperture 303a extends along a portion of a perimeter of the retaining cage 117a. Further, a first width “W1” of the first retaining cage 117a is smaller than a second width “W2” of the second retaining cage 117b. The different widths of the retaining cages 117 enable the adapter 105 to receive sticks and other components of different widths.

Additionally, the adapter 105 may include a hinge 310 that extends from the first retaining cage 117a on a first side of the adapter 105 and from the second retaining cage 117b on a second side of the adapter 105. The hinge 310 is aligned with slots formed from the adapter walls 141a-d (collectively “adapter walls 141”). The adapter walls 141 increase the rigidity of the adapter 105, which is particularly useful when an end of a retaining cage 117 is pivoted. In other embodiments, the adapter 105 and a retaining cage 117 may be separate components, where the retaining cage 117 is attached to the adapter 105. As a non-limiting example, the retaining cage 117 and the adapter 105 may have corresponding apertures for inserting a pivot pin. Particularly, the first end 120 of the retaining cage 117a may have a first pin aperture and the adapter 105 may have a second pin aperture near a center of the adapter 105. The first pin aperture of the retaining cage 117a can align with the second pin aperture of the adapter 105. A pivot pin can be inserted through both the first pin aperture and the second pin aperture. In this example, the second end 1230 of the retaining cage 117 can pivot away the backing 108 because of the attachment of the retaining cage 117a to the adapter 105 by way of the pivot pin.

With reference to FIG. 3B, shown is a cross-sectional view of the adapter 105 and the spring clips 111 with respect to the A-A cross reference in FIG. 3A. FIG. 3B includes an enlarged reference 309 for FIG. 3C. As shown in the illustrated embodiment in FIG. 3B, the spring clips 111 substantially wrap around the retention bars 129. The spring clips 111 come into contact with an inserted paint stick and retain the paint stick within the retaining cages 117. The spring clips 111 keep the paint stick within the retaining cages 117 by applying a force against the surface of the paint stick.

The first spring clip 111a has a slot and the first retention bar 129a is inserted into the slot of the first spring clip 111a. After being inserted in the slot, a tab 312 of the first spring clip 111a raises upward and contacts an inner wall 313 of the first retention bar 129a. The tab 312 prevents the first spring clip 111a from moving in a direction toward the first opening 126a of the first retaining cage 117a. Additionally, the tab 312 may limit the range the first spring clip 111a can move from side to side along the first retention bar 129a.

Additionally, the adapter 105 includes lower cross bars 316 that are situated inside of the first retaining cage 117a. When a paint stick is inserted, it comes into contact with the lower cross bars 316. The spring clip 111 applies a force on the top of the paint stick, and the bottom of the paint stick is supported by the lower cross bars 316. Specifically, the serrated edge 319 of the spring clip 111 contacts the top of the paint stick. In some cases, the serrated edge 319 can insert into the material of the paint stick, particularly if the paint stick is moved in a direction away from the hinge 310.

With regard to attaching the spring clip 111, for example, a first end of the first spring clip 111a is situated below the first retention bar 129a and within the first retaining cage 117a. Then, the first retention bar 129a is inserted into a slot of the first spring clip 111a. While inserting the first spring clip 111, the tab 312 lowers as the first spring clip 111a moves toward the hinge 310. After the tab 31 passes the first retention bar 129a, it moves toward the first window aperture 135a. Then, the tab 312 can contact the inner wall 313 of the first retention bar 129a, which prevents the first spring clip 111a from moving away from the first retention bar 129 and in a direction away from the hinge 310.

With regard to removing, the tab 312 can be pressed to lower it below the first retention bar 129a. After the tab 312 has been lowered, the first spring clip 111a can be moved in a direction away from the hinge 310 and away from the first retention bar 129a.

Next, with reference to FIG. 3C, shown is an enlarged view of the referenced section 309 in FIG. 3B. As shown, the hinge 310 extends from the first retaining cage 117a on one side of the adapter 105 and extends from the second retaining cage 117b on the other side of the adapter 105. The hinge 310 enables the retaining cages 117 to pivot toward each other. Additionally, the retaining cages 117 have the freedom to pivot because of the adapter apertures 303 that extend along the sides of the retaining cages 117. The adapter apertures 303 also extend along an end of the retaining cages 117. For example, the adapter aperture 303a also extends along the second end 123 of the first retaining cage 117a. In some scenarios, one of the retaining cages 117 may be pivoted toward the other retaining cage 117 as a user moves the applicator 102 along a surface. The pivoting action enables a user a greater degree of control with their wrist. As one skilled in the art can appreciate, the retaining cage 117 can be used in other applications for attaching a handle to a tool.

Further, the first retaining cage 117a has a first height “H1” and the second retaining cage 117b has a second height “H2.” The second height H2 is larger than the first height H1. The different heights and different widths (FIG. 3A) of the retaining cages 117 allow for the adapter 105 to receive sticks of different dimensions. Additionally, the lower cross bars 316 have a height “H3,” which is less than both the second height H2 and the first height H1.

Turning to FIG. 3D, shown is a bottom view of the adapter 105 and the spring clips 111 in FIG. 3A. FIG. 3D illustrates that from a bottom side, the adapter 105 has openings that provide access to the interior of the retaining cages 117. As shown, the spring clips 111 have a serrated edge 319 at an end. FIG. 3D also includes a reference arrow “E” for FIG. 3E, a reference arrow “F” for FIG. 3F, and a reference arrow “G” for FIG. 3G.

Referring to FIGS. 3E through 3G, shown are various side views of the adapter 105 and the spring clips 111, which are indicated from reference arrows in FIG. 3D. Particularly, FIG. 3E illustrates a side view of the adapter 105 and the spring clips 111, as indicated by the reference arrow “E” in FIG. 3D. FIG. 3F illustrates another side view of the adapter 105 and the spring clips 111, as indicated by the reference arrow “F” in FIG. 3D. FIG. 3G illustrates an additional side view of the adapter 105 and the spring clips 111, as indicated by the reference arrow “G” in FIG. 3D.

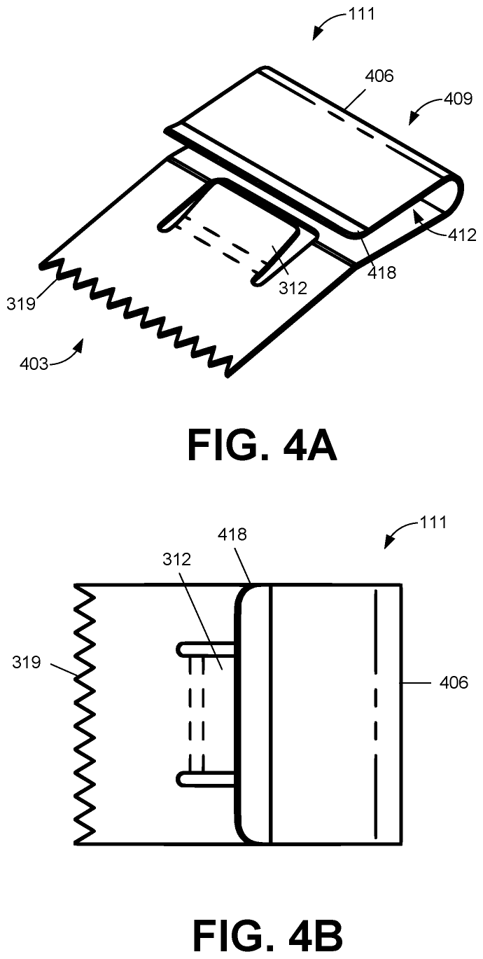

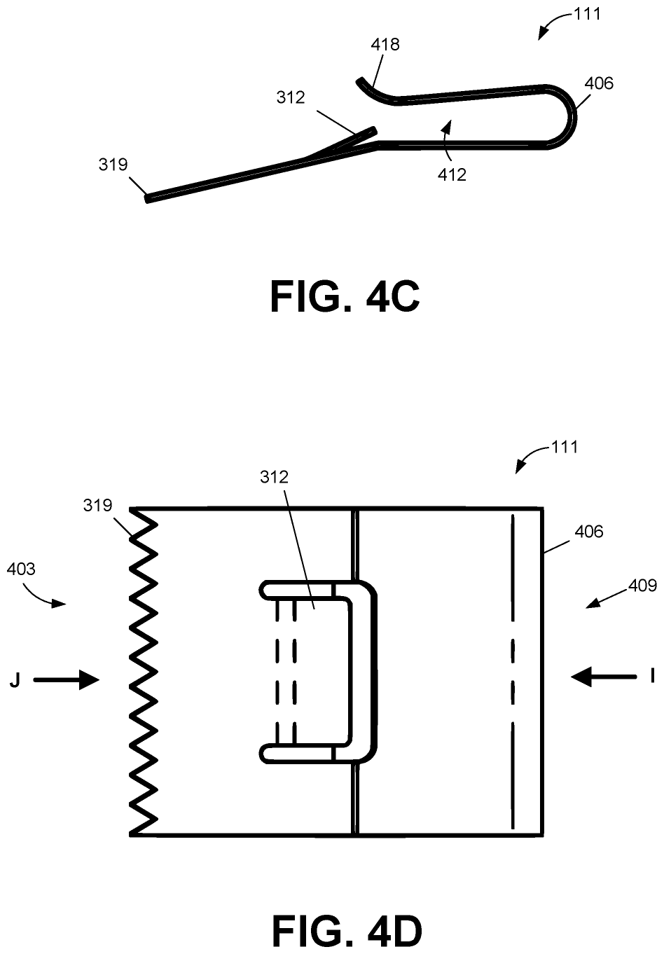

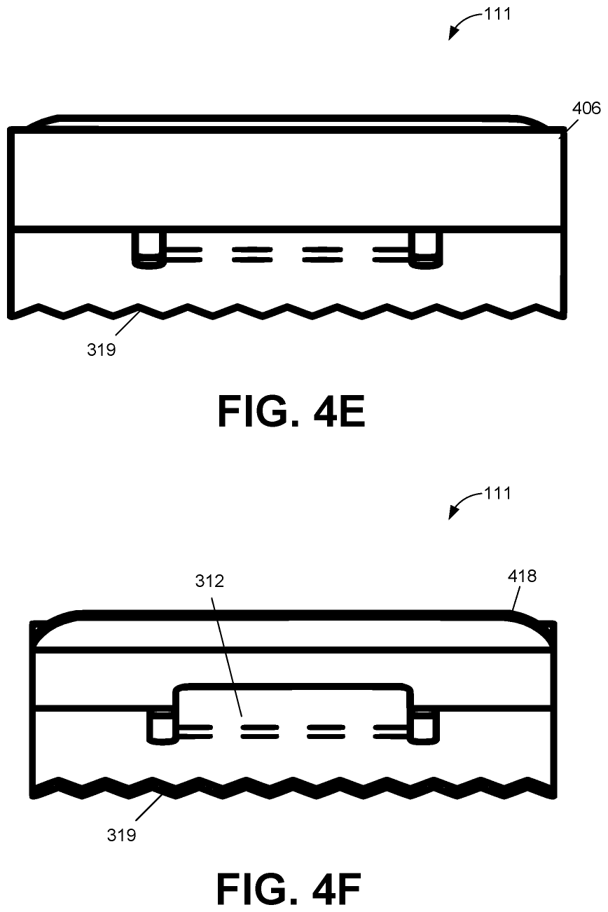

Next, with reference to FIGS. 4A through 4F, shown are various views of the spring clip 111. FIG. 4A illustrates a perspective view of the spring clip 111. As shown, the spring clip 111 has a serrated edge 319 at a first end 403 and a clamp 406 at a second end 409 of the spring clip 111. The clamp 406 forms a slot 412 for receiving the retention bar 129 of the retaining cages 117. At the end of the clamp 406, the spring clip 111 has a lip 418. Additionally, the spring clip 111 includes a tab 312, which tilts toward the lip 418. The tab 312 can be used to contact an inner wall 313 of the retention bar 129 (FIG. 3B). Accordingly, the tab 312 can keep the spring clip 111 from moving away from the hinge 310 (FIG. 3B).

Although the spring clip 111 is shown with a serrated edge 318, the first end 403 of the spring clip 111 can be formed into other types of edges and structures for creating a resistive structure that prevents a paint stick from being removed unintentionally. For example, the first end of the spring clip 111 can have a straight edge or other suitable formations for the end of the spring clip 111.

FIG. 4B illustrates a top view of the spring clip 111 from FIG. 4A. FIG. 4C illustrates a side view of the spring clip 111 from FIG. 4A. FIG. 4D illustrates a bottom view of the spring clip 111 from FIG. 4A. In FIG. 4D, reference arrow “I” is a perspective indicator for FIG. 4E and reference arrow “J” is a perspective indicator for FIG. 4F.

FIG. 4E illustrates a back view of the spring clip 111 from the second end 409 of the spring clip 111, as indicated by the arrow “I.” FIG. 4F illustrates a front view of the spring clip 111 from the first end 403 of the spring clip 111, as indicated by the arrow “J.”

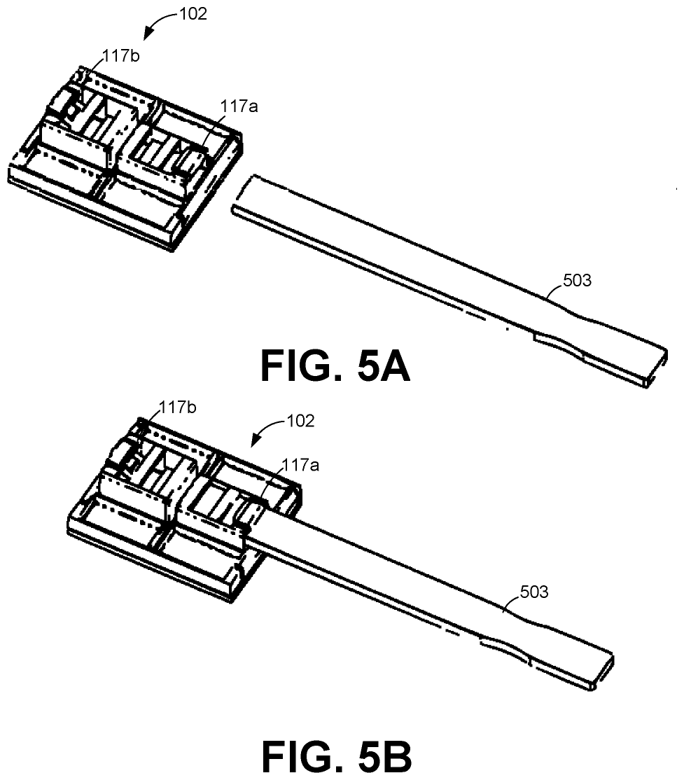

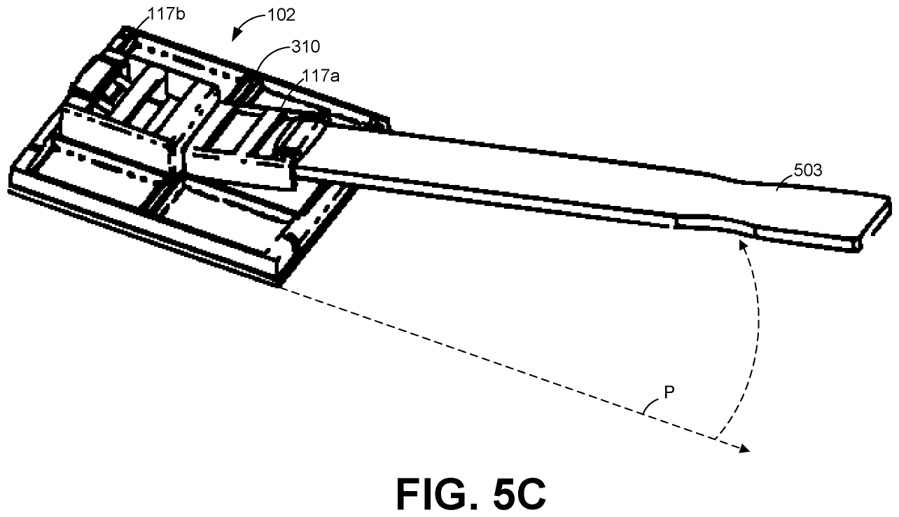

Next, FIGS. 5A through 5C illustrate an exemplary progression for using the applicator 102 with a paint stick 503 in the first retaining cage 117a. The first retaining cage 117a and the second retaining cage 117b can support paint sticks 503 of different dimensions. FIG. 5A illustrates a paint stick 503 being aligned with the first opening 126a of the first retaining cage 117a. Prior to inserting the paint stick 503, the applicator 102 may require a user to assemble the various components.

Next, FIG. 5B illustrates that the paint stick 503 is inserted into the first retaining cage 117a. The serrated edge 319 of the spring clip 111 (FIG. 3B) can be driven into a top portion of the paint stick 503 if it is moved in a direction away from the hinge 310 (FIG. 3B). Then, FIG. 5C illustrates that the first retaining cage 117a is pivoted away from a plane “P.” The first retaining cage 117a is pivoted about the hinge 310 (FIG. 3B). The first retaining cage 117a moves toward the second retaining cage 117b.

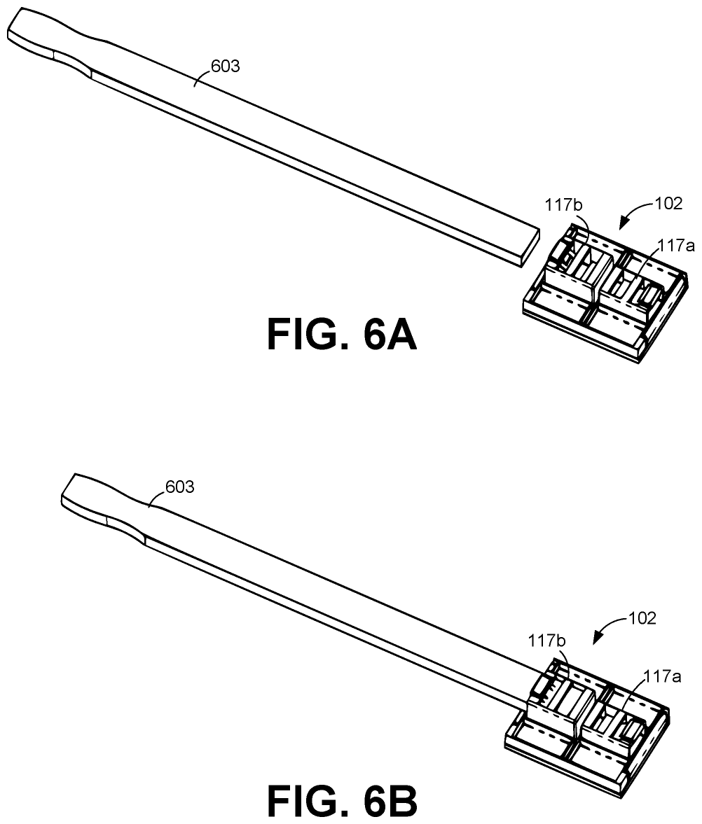

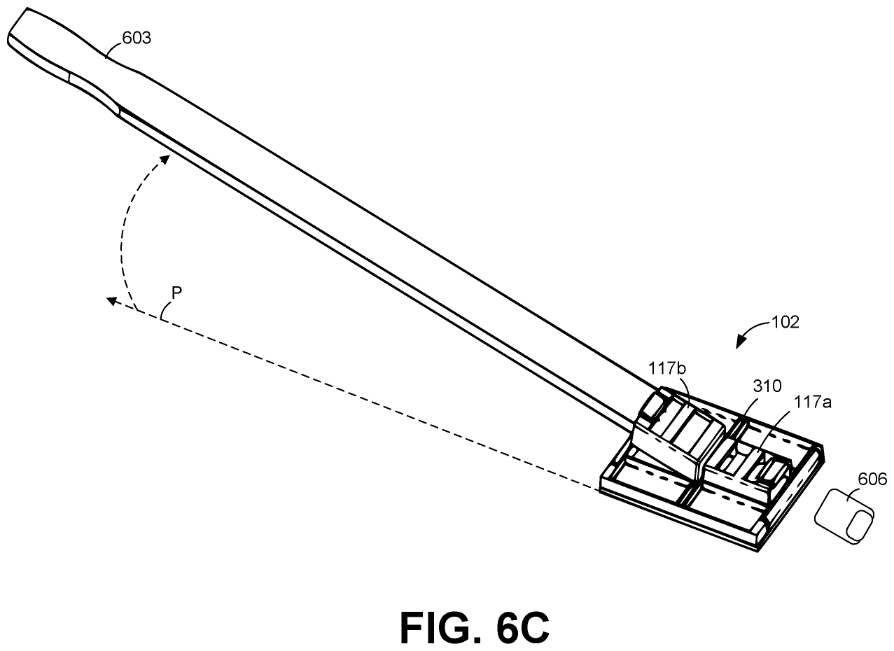

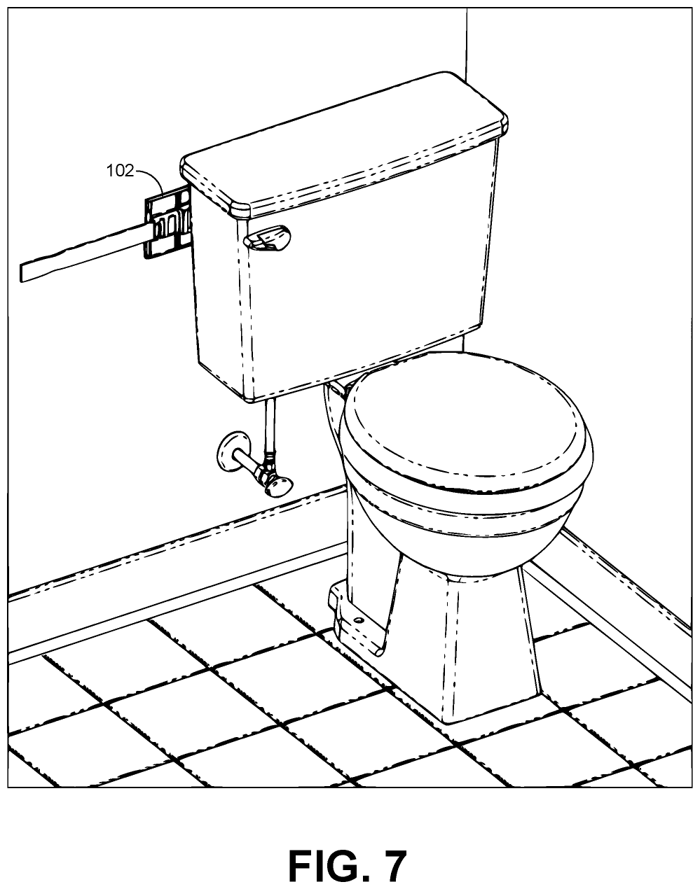

Next, FIGS. 6A through 6C illustrate an exemplary progression for using the applicator 102 with a paint stick in the second retaining cage 117b. FIG. 6A illustrates a paint stick 603 being aligned with the opening of the second retaining cage 117b. In this example, paint stick 603 may be larger than paint stick 503. Thus, paint stick 603 may not fit into the first retaining cage 117a. FIG. 6B illustrates that the paint stick 603 is inserted into the second retaining cage 117b. A serrated edge 319 of the spring clip 111 (FIG. 3B) can be driven into a top portion of the paint stick 603 if it is moved in a direction away from the hinge 310 (FIG. 3B). Then, FIG. 6C illustrates that the second retaining cage 117b is pivoted away from a plane “P.” The second retaining cage 117b is pivoted about a hinge and the second retaining cage 117b moves toward the first retaining cage 117a.

In some embodiments, a lighting device 606 can be inserted into an available retaining cage 117. For example, in FIG. 6C, the lighting device 606 can be inserted into the first retaining cage 117a. The lighting device 606 can include a light emitting diode or other light sources that are battery powered. In this example, the lighting device 606 can be manufactured to the dimensions of the first retaining cage 117a, such as a size of a standard paint stick. The lighting device 606 could be inserted into the retaining cage 117a and secured by the force applied by the spring clip 111.

In other embodiments, the spring clip 111 (FIG. 3B) may be omitted from the adapter 105. In this scenario, the housing of the lighting device 606 may have raised ridges for fitting within one or more of the window apertures 135 (FIG. 1A). In other embodiments, the adapter 105 can be configured to omit one of the retaining cages 117. In this embodiment, the lighting device 606 may extend from a first side of the hinge 310, and the second retaining cage 117b may extend from the second side to a second side of the hinge 310.

FIG. 7 illustrates the applicator 102 used to apply paint along a wall, particularly in confined areas behind a toilet tank.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. An apparatus, comprising:
a paint pad;
an adapter that comprises a top side and a bottom side, the adapter retaining the paint pad on the bottom side, the adapter comprising a retaining cage on the top side; and
wherein the retaining cage comprises a first end and a second end, the retaining cage extending from the adapter at the first end, and the retaining cage comprising an opening at the second end for receiving a paint stick.

2. The apparatus of claim 1, wherein the adapter comprises a hinge, the retaining cage extending from the hinge at the first end, and the hinge enabling the second end of the retaining cage to pivot away from a plane associated with the bottom side of the adapter.

3. The apparatus of claim 1, wherein the retaining cage is attached to the adapter with a pivot pin.

4. The apparatus of claim 1, wherein the retaining cage is a first retaining cage, and the adapter comprises a second retaining cage, wherein the first retaining cage and the second retaining cage are connected to a hinge of the adapter.

5. The apparatus of claim 4, wherein the first retaining cage comprises a first width and a first height, and the second retaining cage comprises a second width and a second height, wherein the second width is larger than the first width and the second height is larger than the first height.

6. The apparatus of claim 1, further comprising a backing that retains the paint pad, the backing comprising an overhang at a side, wherein the overhang is disposed onto an edge of the adapter.

7. The apparatus of claim 1, further comprising a spring clip that attaches to a retention bar at the second end of the retaining cage.

8. The apparatus of claim 7, wherein the spring clip comprises a tab that contacts an inner wall of the retention bar.

9. The apparatus of claim 7, wherein the spring clip comprises a serrated edge at a first end of the spring clip and a slot at a second end of the spring clip.

10. The apparatus of claim 1, wherein the adapter comprises a plurality of walls that form a first slot and a second slot that align with a hinge of the adapter.

11. The apparatus of claim 1, wherein the retaining cage comprises a first raised crossbar and a second raised crossbar that form a first window aperture and a second window aperture.

12. The apparatus of claim 11, wherein the first raised crossbar and the second raised crossbar are at a first height, and wherein the retaining cage comprises a lowered crossbar at second height that is less than the first height.

13. The apparatus of claim 1, wherein the adapter comprises an aperture that extends along a first side of the retaining cage, the second end of the retaining cage, and a second side of the retaining cage.

14. An applicator, comprising:
a pad;
an adapter that comprises a top side and a bottom side, the adapter retaining the pad on the bottom side, the adapter comprising a retaining cage on the top side, wherein the adapter comprises an aperture that extends along a portion of the retaining cage; and
wherein the retaining cage comprises an opening for receiving a paint stick.

15. The applicator of claim 14, wherein the adapter comprises a recessed channel at an edge of the adapter.

16. The applicator of claim 15, wherein the recessed channel comprises a first stop and a second stop.

17. The applicator of claim 14, wherein the retaining cage comprises a first end and a second end, the adapter comprises a hinge, and the retaining cage extends from the hinge at the first end of the retaining cage, the hinge enabling the second end of the retaining cage to pivot away from a plane associated with the bottom side of the adapter.

18. The applicator of claim 17, further comprising a spring clip that attaches to a retention bar at the second end of the retaining cage.

19. The applicator of claim 18, wherein the spring clip comprises a tab that contacts an inner wall of the retention bar.

20. The applicator of claim 18, wherein the spring clip comprises a serrated edge at a first end of the spring clip and a slot at a second end of the spring clip.
